(19) United States
(12) Patent Application Publication
(10) Pub. No.: US 2022/0027378 A1
(43) Pub. Date: Jan. 27, 2022

(54) DATA STORAGE AND MANIPULATION

(71) Applicant: Mammoth Software Inc., San Francisco, CA (US)

(72) Inventors: Gaurav Dudhoria, San Francisco, CA (US); Pankaj Ratan Lal, Bangalore (IN); Ranjith Brahmin Ramachandra, Virajpet (IN); Yogesh Mangaj, Belgaum (IN); Lina Castaneda, London (GB); Daniel Williams, San Luis Obispo, CA (US)

(21) Appl. No.: 17/296,937

(22) PCT Filed: Nov. 29, 2019
(86) PCT No.: PCT/EP2019/083148

§ 371 Date: May 25, 2021

(51) Int. Cl. G06F 16/25

(52) U.S. Cl. CPC G06F 16/254

(57) ABSTRACT

A system of data architecture and user interface for storing and manipulating data. The system comprises an application layer (20) in two-way data communication with an application database (40) and a data transformation layer (30). The data transformation layer (30) is in two-way data communication with a data database (50), the application layer (20) is in two-way data communication with a user interface (70), and the application layer (20) is in two-way communication with the data database (50).

### FIELD OF THE INVENTION

The present inventive concept lies in the field of business data storage and manipulation.

### BACKGROUND TO THE INVENTION

Spreadsheet software is a well-known genre. Data can be stored in a spreadsheet, and straightforward calculations and transformations can be made therewith.

However, spreadsheets can rapidly become large and complex and thus errors can arise.

The current landscape consists of different products that address the different parts of the data journey.

Existing (prior-art) solutions cover small phases within the data journey (i.e. data preparation, data visualisations, data storage, etc.). This fragmentation of solutions affects users, who have few alternatives but to use a variety of products and services to satisfy their data management needs.

Furthermore, previous efforts have required extensive programming knowledge because they require use of a command line interface.

### SUMMARY OF INVENTION

The present inventive concept provides a system of data architecture and user interface for storing and manipulating data comprising an application layer in two-way data communication with an application database and a data transformation layer, the data transformation layer being in two-way data communication with a data database, the application layer being further in two-way data communication with a user interface, and the application layer being further in two-way communication with the data database.

The user interface comprises a plurality of substantially neighbouring areas, each area being related to a pre-determined specialised use. The areas may be substantially rectangular. A combination of areas may therefore provide a combination of technical features and functionality to a user. For example a dataview may comprise a series of areas, namely a pipeline area, an explore area, a data grid area and an elements area.

An area may also sometimes be referred to as a panel.

The data grid area may comprise a tabular view of data displayed in rows and columns. The data displayed in the data grid area depends on an action (sometimes referred to as a task) performed in the pipeline area.

In turn, the pipeline area displays a record of tasks performed on data, in substantially chronological order.

The user interface may further comprise an area for adding tasks to be performed. Tasks added will be performed on data and added to the pipeline area. The further area may sometimes be referred to as a function panel. The function panel may be located substantially adjacent the data grid. The function panel may comprise a series of selectable pre-determined functions. Once a function is selected it may become a task and thus performed on data. Example functions include “join two datasets”, “remove duplicates”, “search and replace”.

The explore area may provide a consolidated view of the data grid area, using one or more explore cards. Explore cards may comprise a summarised representation of selected columns. For example a user may create an explore card for a column that has certain values; a summarised view may show a histogram representing those values.

For each explore card, a user may choose a display mode to display a relevant subset of the data linked to that explore card. In that display mode, the relevant data may be shown as an anchor in a different part of the user interface. In that display mode, remaining areas of the user interface will display data relating to the data shown as the anchor.

The explore card arrangement may thus be iterative, in that a user can further select an explore card in respect of data shown as an anchor. In that way the user may “drill down” into the data.

For example, a column may comprise a list of months. An explore card may be selected to display data only relating to January, then the remaining areas of the user interface will show data relating to January. A further explore card may subsequently be selected to select to display data meeting the relevant criterion or criteria, within the already selected January subset.

The user interface may comprise an element area. Selectable functions within the element area may include creating elements and viewing elements. Elements may be one of metrics, tables or charts.

Metrics are single value units which are either an aggregate or a conditional outcome, and may include numerical, text or format information. For example, a metric may include such information as “total sales”, “most common word” and the like.

Tables are a tabular representation of a subset of data from the data grid area.

Charts are summarised data from the data grid area, presented in a graphical form. Examples include histograms, pie charts, maps and the like.

The element area may comprise more than one function. Each function may be repositioned within the element area, and/or resized, based on user preference. The element area provides different states of representation from the data grid. For example, the element area may be shown alongside the data grid and be approximately one quarter of the size of the data grid. In other words, the element area may comprise approximately 20% of space of the user interface, and the data grid approximately 80%. A user may vary the relative sizes and positions of the data grid and element area, according to preference.

As set out above, the system comprises an application layer, a data transformation layer, and application database and a data database.

The application layer provides rendering data for presentation in the dataview. The application layer communicates with the data transformation layer for reading, writing, rending of data between the dataview and other elements of the system.

The data transformation layer communicates with the data database and the application layer. The data transformation layer has a pipeline manager, a derivatives manager and a query manager.

The pipeline manager provides for a task to be added to the pipeline area. A task may be “add new column” or “filter data” or the like.

The derivatives manager may provide data, such as relating to a metric or an explore card.

The query manager provides a conduit between the data database and the application layer. All data transferred between the data database and the application layer is via the query manager.

The present inventive concept has many advantages. Advantages are achieved by a combination of different visual interfaces and a technology architecture that supports them. Examples of advantages include: storage and viewing of large datasets; viewing and exploring datasets in different resolutions; performing transformations on data sets; automating such transformations; visualising and summarising via charts and metrics; setting up conditional or scheduled alerts; exporting data into different channels.

The present inventive concept may be implemented to provide a single webpage that can be viewed in different formats that enables the above mentioned advantages.

By combining features in a synergistic manner, the present inventive concept provides a cohesive solution. The system provides a synergistic interaction to support aspects of data flow.

The present inventive concept provides a service for approximately 95% of users' needs for data management. The remainder 5% of users who cannot use Mammoth require a more advanced and programmer-friendly solution.

### DETAILED DESCRIPTION OF THE INVENTION

Aspects of the present inventive concept will now be described, by way of example only, with reference to the accompanying drawings, in which:

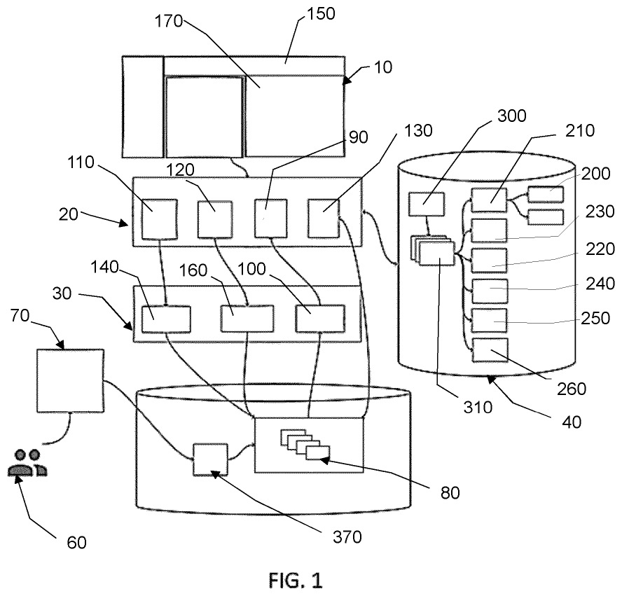

FIG. 1 shows representations of aspects of the present inventive concept, in a form intended to show links and interactions between constituent parts of the inventive concept;

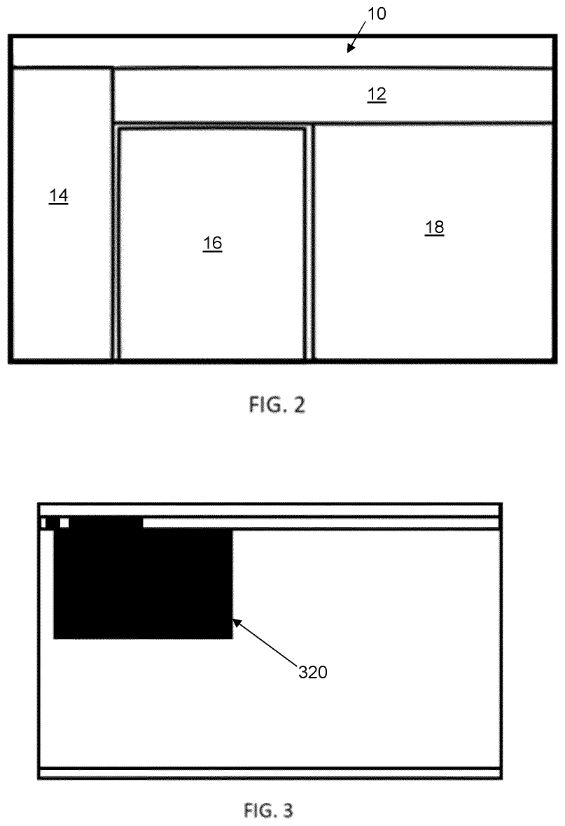

FIG. 2 shows a representation of a Dataview part;

FIG. 3 shows a representation of a Task Menu part;

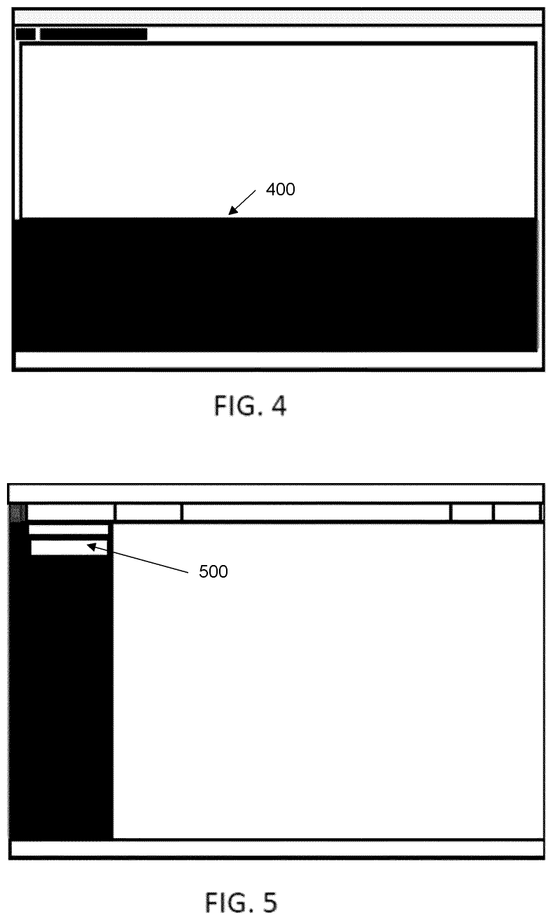

FIG. 4 shows a representation of a Function Panel part;

FIG. 5 shows a representation of a Data preparation Steps part;

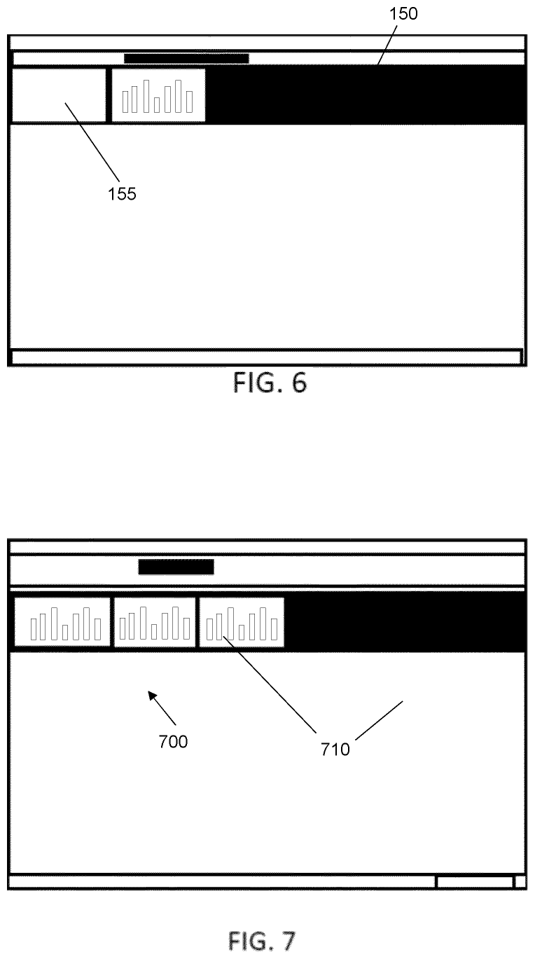

FIG. 6 shows a representation of an Explore Card part;

FIG. 7 shows a representation of a Drilldown Filter and resulting Filtered Data part;

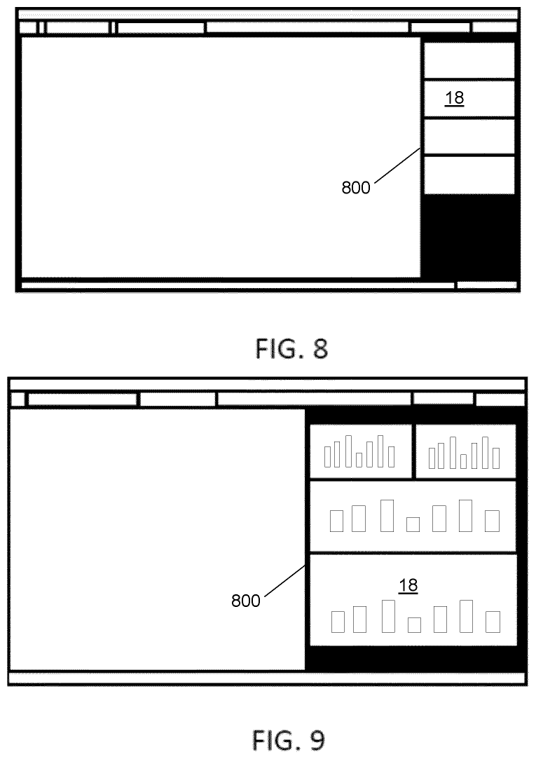

FIG. 8 shows a representation of an Elements part; and

FIG. 9 shows a further representation of the Elements part.

Turning to FIG. 1, there is shown a system comprising a dataview 10, an application layer 20, a data transformation layer 30, an application database 40, and a data database 50. When data is added by a user 60 into the system of the present invention (via a user interface 70) it gets placed in the data database 50. Any new data in the data database 50 undergoes a process of optimisation. The optimisation involves copies of original data 370 and associated meta-data tables stored in optimised data tables 80. When the user 60 opens a dataview page, 10, a “Render” operation 90 communicates with a query manager 100 to retrieve all data from the optimised data tables 80. This data is rendered on the webpage.

Dataview 10 comprises an explore view 12, a pipeline view 14, a grid view 16 and an elements view 18.

The application database 40 stores the latest version of the data from the optimised data tables 80. The application database 40 comprises a dataset 300 and views 310. To obtain the data from the optimised data tables 80, the application database 40 communicates via the application layer 20 (which comprises “Transform” 110, “Derive” 120, “Render” 90, and “Special Functions” 130 functions).

Via the application layer 20 in the dataview 10, the user 60 can perform various types of actions provided in the application database 40:

Transformation—When the user performs a transformation, the Transform module 110, 200 communicates to a pipeline manager 210, and 140 in the data transformation layer 30 with instructions on the type of transformation, e.g. replace certain values. The pipeline manager 140 records a step in a pipeline section and updates the optimised data tables 80.

Exploration—users can obtain summaries of columns and drill down on the data. When the user explores a column using an “explore function” 150 in the dataview 10 and 220 in the application database, an “Explore Card” 155 is generated showcasing the summary of the column. This Explore Card 155 displays the unique values of the column and its number of occurrences. The Explore Card 155 is generated via a “Derive” module 120, which talks to a derivative manager 160 in the data transformation layer 30 which either reads from or writes to the optimised data tables 80.

Elements 170 in dataview 10 and 230 in the application database are summarised values (Charts, Tables or Single Value Metrics) that are placed on the right panel in the dataview 10. The mechanism of creation and saving is the same as the Explore Section 150.

Alerts 240 are user defined alerts that are sent to users via email, SMS and other communication platforms.

Grid 250 is the current state of the data after its transformed state.

Export 260—Users can export the data from the table via an Export button at any time. This is performed via a Special Function module that talks directly to the Optimised Data Tables. Data can be exported as a download, sent to a Database, sent via Email or sent to a Cloud Drive.

FIGS. 2 to 9 show further representations of the elements of FIG. 1.

FIG. 3 shows a representation of a Task Menu part, generally indicated 320;

FIG. 4 shows a representation of a Function Panel part, generally indicated 400;

FIG. 5 shows a representation of a Data preparation Steps part, generally indicated 500;

FIG. 6 shows explore panel 150 and explore cards 155.

FIG. 7 shows a drilldown filter, generally indicated 700 and filtered data generally indicated 710.

FIGS. 8 and 9 demonstrate an element panel 18 toggle, 800. FIG. 8 shows a representation of an Elements part 18 in an 80/20 view and FIG. 9 shows a further representation of the Elements part 18 in a 60/40 view.

1. A system of data architecture and user interface for storing and manipulating data comprising
an application layer in two-way data communication with an application database; and
a data transformation layer, the data transformation layer being in two-way data communication with a data database, the application layer being further in two-way data communication with a user interface, and the application layer being further in two-way communication with the data database.

2. A system as claimed in claim 1, wherein the user interface comprises a plurality of substantially neighbouring areas, each area being related to a pre-determined specialised use.

3. A system as claimed in claim 1, wherein the areas are substantially rectangular.

4. A system as claimed in claim 1, further comprising a dataview.

5. A system as claimed in claim 4, wherein the dataview comprises a series of areas, namely a pipeline area, an explore area, a data grid area and an elements area.

6. A system as claimed in claim 5, where the data grid area comprises a tabular view of data displayed in rows and columns, and wherein the data displayed in the data grid area depends on an action performed in the pipeline area.

7. A system as claimed in claim 5, wherein the pipeline area displays a record of tasks performed on data, in a substantially chronological order.

8. A system as claimed in claim 1, wherein the user interface further comprises an area for adding tasks to be performed.

9. A system as claimed in claim 8, wherein tasks added are performed on data and added to the pipeline area.

10. A system as claimed in claim 9, wherein the explore area provides a consolidated view of the data grid area, using one or more explore cards.

11. A system as claimed in claim 1, wherein the user interface comprises an element area, wherein selectable functions within the element area comprise creating elements and viewing elements.

12. A system as claimed in claim 11, wherein the element area comprises more than one function, wherein each function may be repositioned within the element area, and/or resized, based on user preference.

13. A system as claimed in claim 4, wherein the application layer provides rendering data for presentation in the dataview, wherein the application layer communicates with the data transformation layer for reading, writing, rending of data between the dataview and other elements of the system.

14. A system as claimed in claim 1, wherein the data transformation layer comprises a pipeline manager, a derivatives manager and a query manager.

15. A system as claimed in claim 14, wherein the pipeline manager provides for a task to be added to the pipeline area.

16. A system as claimed in claim 14, wherein the derivatives manager provides data.

17. A system as claimed in claim 14, wherein the query manager provides a conduit between the data database and the application layer, wherein all data transferred between the data database and the application layer is via the query manager.
